(19) United States
(12) Patent Application Publication
(10) Pub. No.: US 2020/0153287 A1
(43) Pub. Date: May 14, 2020

(54) ENERGY TRANSMISSION SYSTEM INCLUDING ORBITING COMPONENTS

(71) Applicant: Charles William Polk, Seattle, WA (US)

(72) Inventor: Charles William Polk, Seattle, WA (US)

(21) Appl. No.: 16/676,117

(22) Filed: Nov. 6, 2019

Related U.S. Application Data
(60) Provisional application No. 62/760,019, filed on Nov. 12, 2018.

(51) Int. Cl. H02J 50/30; B64G 1/44; B64G 1/42

(52) U.S. Cl. CPC H02J 50/30; B64G 1/428; B64G 1/443

(57) ABSTRACT

Methods and systems for generating energy at a platform in orbit around a planet or a moon and beaming at least a portion of the generated energy to a user receiver. One of the methods includes: generating energy at an energy generating platform in orbit around a planet to produce generated energy; transmitting at least some of the generated energy from the energy generating platform to a relay platform in orbit around the planet, the energy generating platform transmitting at least some of the generated energy using at least one laser; and relaying, using the relay platform, at least some of the generated energy received from the energy generating platform to a user receiver.

### CROSS-REFERENCE TO RELATED APPLICATIONS

This application claims the benefit under 35 U.S.C. § 119(e) of the filing date of U.S. Provisional Patent Application No. 62/760,019, titled “The Skylight System: A Space-Based Electricity Grid using Laser-Power Beaming to transfer Electricity from Solar-Electric Generating Platforms for Multiple Uses”, which was filed on Nov. 12, 2018, and which is incorporated herein by reference in its entirety.

### BACKGROUND

### Technical Field

This specification relates to energy transmission using laser power beaming.

### Background

In laser power beaming, electricity is converted into laser light by a laser emitter and projected as a laser beam to a receiver and the receiver converts the laser light to electricity so as to be able to supply energy to a user. Even an ideal laser beam diverges with distance due to diffraction, which affects the practicality of power beaming with distance, or range.

The divergence of the beam increases with the wavelength of the laser light and decreases with the width of the beam at its narrowest point along the projected path from laser emitter to user receiver. For an unfocused beam, this narrowest point is the diameter of the laser emitter. For a focused beam, this narrowest point is the width of the beam at the focal point. Beam divergence and related aspects of laser design are important considerations for laser power beaming.

### SUMMARY

This specification describes technologies for generating energy at a platform in orbit around a planet or a moon and beaming at least a portion of the generated energy to a user receiver. A system can arrange Generating and Laser beaming Platforms (GLPs) and Relay Platforms (RPs) to form a constellation of GLPs and RPs that can efficiently transmit energy to user receivers.

In general, one innovative aspect of the subject matter described in this specification can be embodied in methods that include the actions of: generating energy at an energy generating platform in orbit around a planet to produce generated energy; transmitting at least some of the generated energy from the energy generating platform to a relay platform in orbit around the planet, the energy generating platform transmitting at least some of the generated energy using at least one laser; and relaying, using the relay platform, at least some of the generated energy received from the energy generating platform to a user receiver. Alternatively, instead of a planet the energy generating platform and the relay platform can be in orbit around a moon, e.g., the Earth's moon.

The foregoing and other embodiments can each optionally include one or more of the following features, alone or in combination. In particular, one embodiment includes all the following features in combination. Transmitting at least some of the generated energy using at least one laser can use at least a first laser beam, relaying the generated energy received from the energy generating platform to a user receiver can include transmitting at least some of the generated energy using at least a second laser beam and the energy generating platform and the relay platform can be configured to transmit energy to a user receiver over a greater angular separation, as measured from the center of the planet compared to transmitting energy directly from the generating platform to the user receiver. Transmitting at least some of the generated energy using at least a second laser beam can include using a mirror on the relay platform to reflect the first laser beam such that the second laser beam is a result of the first laser beam being reflected by the mirror.

More generally, the relay platform can include a relaying mirror and relaying the generated energy can include relaying the generated energy using the relaying mirror. Alternatively, the relay platform can convert the first, or incoming, laser beam to electricity using any of several means such as a photovoltaic or heat engine and then use a laser emitter on the relay platform to produce the second, or outgoing, laser beam to relay at least some of the incoming energy to a user receiver. In addition or alternatively, the user receiver can convert an incoming laser beam to electricity using any of several means such as a photovoltaic or heat engine. Relaying the generated energy can include tracking and targeting, using the relay platform, the user receiver. Transmitting at least some of the generated energy from the energy generating platform to a relay platform can include tracking and targeting the relay platform. Targeting the user receiver can include using cooperative beam lock control.

Generating energy at an energy generating platform can include the conversion of sunlight into electricity. Generating solar energy can include absorbing sunlight at a photovoltaic cell and converting the sunlight to electrical energy using the photovoltaic cell and the method can further include transmitting the electrical energy to at least one laser-based transmission system. The user receiver can receive transmitted energy sufficient to provide at least 0.5 Megawatts of power.

In certain implementations, the total distance between the energy generating platform, relay platform, and the user receiver can be at least 1,000 km. The user receiver(s) can include aircraft, ships, or stationary installations or a combination of these.

The method can further include: generating energy at a plurality of energy generating platforms in orbit around the planet to produce generated energy; transmitting at least some of the generated energy from the plurality of energy generating platforms to a plurality of relay platforms in orbit around the planet, each of the plurality of energy generating platforms transmitting at least some of the generated energy using at least one laser; and relaying, using the plurality of relay platforms, at least some of the generated energy received from the plurality of energy generating platform to a plurality of user receivers, wherein the plurality of energy generating platforms and the plurality of relay platforms are configured relative to the plurality of user receivers such that the generated energy can be distributed among the plurality of user receivers while reducing surplus generation capacity and unfulfilled user energy demand relative to the same plurality of energy generating platforms without a plurality of relay platforms. In one implementation, the planet is Earth and the plurality of energy generating platforms are in orbit around the Earth in sun-synchronous orbits, 1,000 kilometers above the Earth, that track the day-night boundary such that each of the plurality of energy generating platforms is in constant illumination from sunlight throughout the year for all but the period around the northern winter solstice when daily illumination decreases to no less than 21 hours and the plurality of relay platforms are in orbits 6,000 kilometers above the Earth with orbital inclinations that facilitate the beaming of power to user receivers.

Transmitting at least some of the generated energy using at least one laser can use at least a first laser beam, relaying the generated energy received from the energy generating platform to a user receiver can include transmitting at least some of the generated energy using at least a second laser beam and the energy generating platform, the relay platform, and the user receiver can be configured such that the first laser beam and the second laser beam do not diverge more than a certain amount prior to arriving at their respective targets such that less than 15% of transmitted energy is lost.

In general, another innovative aspect of the subject matter described in this specification can be embodied in methods that include the actions of: generating energy at an energy generating platform in orbit around a planet or moon to produce generated energy; transmitting at least some of the generated energy from the energy generating platform to a relay platform in orbit around the planet or moon, the energy generating platform transmitting at least some of the generated energy using at least one laser; and relaying, using the relay platform, at least some of the generated energy received from the energy generating platform to a user receiver.

In general, another innovative aspect of the subject matter described in this specification can be embodied in a system that includes: a generating platform in orbit around a planet or moon, the generating platform including: (i) at least one photovoltaic cell configured to convert sunlight to electrical energy; and (ii) at least one laser-based transmission system configured to receive electrical energy from the photovoltaic cell and to transmit at least some of the electrical energy as transmitted energy using at least one laser; and a relay platform in orbit around the planet or moon, the relay platform configured to receive at least some of the transmitted energy and to relay at least some of the transmitted energy to a user receiver.

The foregoing and other embodiments can each optionally include one or more of the following features, alone or in combination. In particular, one embodiment includes all the following features in combination. The system can further include a user receiver configured to receive at least some of the transmitted energy. The energy generating platform can be configured to transmit at least some of the electrical energy as transmitted energy using at least one laser producing at least a first laser beam, the relay platform can be configured to relay at least some of the transmitted energy to a user receiver by transmitting at least some of the transmitted energy using at least a second laser beam and the energy generating platform and the relay platform can be configured to transmit energy to a user receiver over a greater angular separation, as measured from the center of the planet compared to transmitting energy directly from the energy generating platform to the user receiver.

Transmitting at least some of the transmitted energy using at least a second laser beam can include using a mirror on the relay platform to reflect the first laser beam such that the second laser beam is a result of the first laser beam being reflected by the mirror.

The subject matter described in this specification can be implemented in particular embodiments so as to realize one or more of the following advantages. The use of RPs allows the generating capacity of a GLP to be transmitted to users that are too separated from the GLP to be effectively serviced, or serviced at all, by the GLP directly. GLPs are more massive, complex, and substantial constructions and investments than are RPs. RPs therefore provide service flexibility to a laser beaming system in a more cost and resource efficient manner than would a system composed only of GLPs.

When the GLPs are in motion relative to the users, as will generally be the case for users on or near the surface of the planet or moon about which the GLPs orbit, the distribution of demand—the users—will only rarely match the distribution of supply the GLPs. By employing a constellation composed of GLPs and more numerous RPs, the generation capacity of GLPs about the planet or moon can be redistributed to match user demand as needed.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating one example of laser power beaming.

FIGS. 2A and 2B are diagrams illustrating unfocused and focused laser beams, respectively, and in particular how the concept of the Rayleigh Length applies to both.

FIG. 3 is a diagram illustrating one example of a constellation of generating platforms and relay platforms.

FIG. 4A is a diagram illustrating an example of a generating platform and user receiver configuration without a relay platform.

FIG. 4B is a diagram illustrating another example of a generating platform, relay platform, user receiver configuration.

FIG. 5 is a diagram illustrating a 3 dimensional perspective of one example of a constellation of generating platforms and relay platforms.

FIG. 6 is a flow-chart illustrating one example of a process for space-based energy transmission using laser power beaming.

Like reference numbers and designations in the various drawings indicate like elements.

### DETAILED DESCRIPTION

Implementations of a system described in this specification provide a space-based electricity grid, using laser-power beaming to transfer electricity from solar-electric generating platforms for multiple uses. Such a system can be used to power air transport, by supplanting or supplementing jet fuel, and combustion generally, for propulsion by providing the power for electric-motor-driven aircraft engines. Such a system can also service other terrestrial, earth-orbital, cislunar, and solar-system uses.

### Laser-Power Beaming

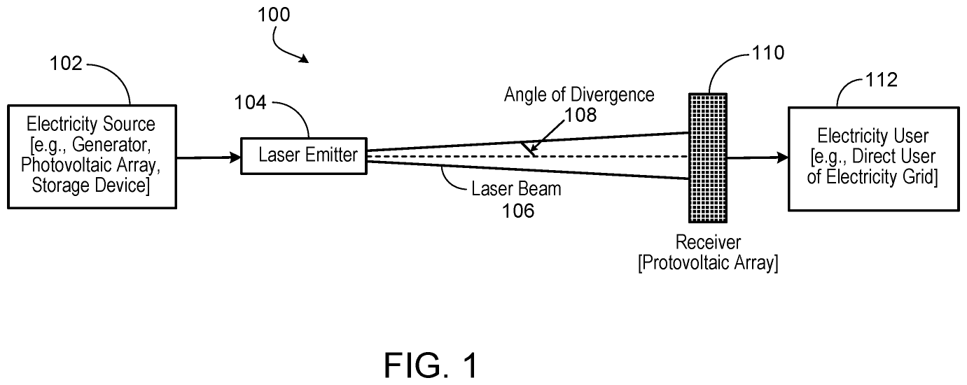

The elements of laser-power beaming are illustrated in FIG. 1. An electricity generator/source 102 such as a photovoltaic (PV) array can generate electricity and transfer the electricity to a laser emitter 104. Electricity is converted into laser light by the laser emitter 104 and projected as a laser beam 106 to a receiver 110, the receiver converting the laser light to electricity that is supplied to a user 112. The receiver 110 can be a PV array that directly converts the light to electricity (plus waste heat) or a heat exchanger that is part of a generating system. In FIG. 1, the illustrated receiver 110 is a PV array. An attribute of the laser beam is its angle of divergence 108, which affects the practicality of power beaming with distance, or range.

The divergence of an unfocused laser beam is illustrated in FIG. 1. The angle of divergence 108 increases with the wavelength of the laser light and decreases with the width of the beam at the point it is emitted from the laser emitter. For a focused laser beam, the width that affects divergence is the width at the focal point. It will be assumed, though it's not required, that the laser has a circular cross section and thus the widths in question are diameters.

### Laser for Long-Range Power Beaming

Beaming power using a laser over long ranges—here defined as distances over 1,000 kilometers (km)—implies that either (i) the beam divergence is so low that it is practical to have a user receiver large enough to receive the vast majority of the cross section of the beam or (ii) transmission losses with distance are acceptable as more of the cross section of the beam exceeds the bounds of the receiver. The merits of laser power beaming will be greatest if (i) pertains, and, further, if (i) pertains over a broad range of ranges. A High-Energy Laser that meets (i) and is capable of delivering large amounts of power over long periods of time differs from high-energy lasers designed for cutting and welding.

A laser has a wavelength, power output, emitter aperture (diameter of the emitter, assuming circular cross section), and beam quality. Assume for the following discussion, a single-mode, perfectly collimated, Gaussian beam (i.e., intensity varies across the beam's cross-section as a Gaussian distribution). Even such a high-quality beam diverges due to diffraction—this can drive the design of the Laser. The following discussion assumes Gaussian beams operating in a vacuum. The conclusions are qualitative and hold for beams that are not completely Gaussian and for operations in a medium that is transparent to the laser.

The divergence of a Gaussian beam increases with the wavelength of the laser and decreases with the beam waist, the radius of the laser at its narrowest point. To minimize the radius of the projected beam spot relative to the beam radius at the emitter, the laser-beaming-system design relies on a property of the Rayleigh Length, which is defined as the distance from the beam waist at which divergence has doubled the area of the spot (increased the spot radius by a factor of the square root of two). The formula for the Rayleigh Length is:

$${z}_{R} = \frac{π {w}_{0}^{2}}{λ} ⇒ {w}_{0} = \sqrt{\frac{{z}_{R} λ}{π}} , and noting {w}_{R} = {w}_{0} \sqrt{2}$$

where λ is the wavelength of the laser, w₀ is the beam waist (radius at the narrowest point of the beam), z_{R} is the distance from w₀ (here, the Rayleigh Length), and w_{R} is the beam radius at the Rayleigh Length. The formula for the beam radius at a distance z from the waist is:

$$w ( z ) = {w}_{0} \sqrt{1 + {( \frac{z}{{z}_{R}} )}^{2}} where {z}_{R} is the Rayleigh Length$$

The change in beam radius, w(z), with distance, z, from the beam waist, w₀, increases toward a constant as z becomes larger than the Rayleigh Length, z_{R}. If one is free to choose the beam waist, w₀, then beam divergence in laser power beaming is most effectively managed by keeping the maximum transmission range within the Rayleigh Length, if the laser beam is not focused beyond the emitter, or within twice the Rayleigh Length, if the laser beam is focused beyond the emitter.

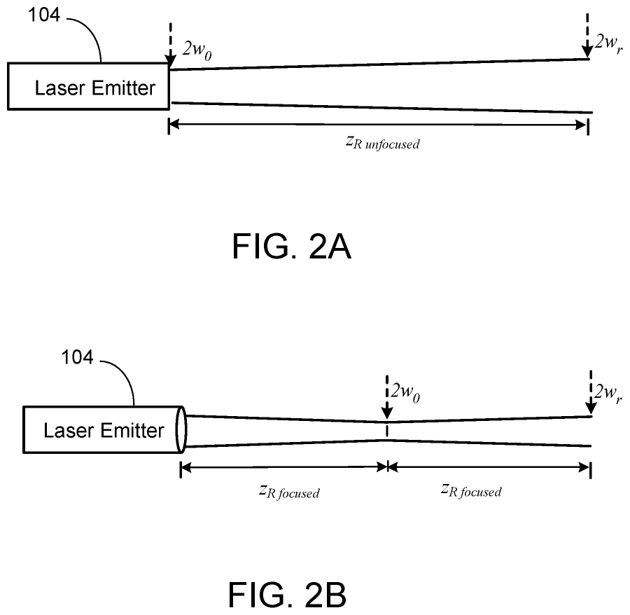

For improving laser beam spot size with power beaming range, there are two geometries of interest, one for an unfocused beam and the other for a focused beam, as illustrated in FIGS. 2A and 2B, respectively.

To improve spot size for an application, the diameter of the laser emitter should be chosen to reduce, e.g., minimize, spot size at the longest range of the application, which will be z_{R,unfocused} for an unfocused laser and 2z_{R,focused} for a focused laser, noting that for a specific application z_{R,unfocused}=2z_{R,focused}. From the expression for the Rayleigh Length, it can be shown that the optimal diameter of the laser emitter for a power beaming application is the same whether the laser is focused or unfocused. Defining D as the diameter of the laser emitter and employing the definition of the Rayleigh Length above:

$${w}_{0 , focused} = \sqrt{\frac{λ}{π} {z}_{R , focused}} = \frac{{D}_{focused}}{2 \sqrt{2}}$$

$${w}_{0 , unfocused} = \sqrt{\frac{λ}{π} {z}_{R , unfocused}} = \frac{{D}_{unfocused}}{2}$$

$$\frac{{D}_{focused}}{2} = \sqrt{\frac{2 λ}{π} {z}_{R , focused}}$$

$$\frac{{D}_{unfocused}}{2} = \sqrt{\frac{λ}{π} {z}_{R , unfocused}}$$

$$noting that \text{:} 2 {z}_{R , focused} = {z}_{R , unfocused} ⇒ {D}_{focused} = {D}_{unfocused}$$

The projected spot at the maximum range will be smaller for the focused laser than for the unfocused, but the diameter of the laser emitters will be the same.

A representative wavelength for laser power beaming when the receiver is a photovoltaic array is 800 nanometers (nm), which is infrared light just beyond visible range. Below are listed laser emitter diameters for a laser of this wavelength for applications with several maximum ranges:

Emitter Diameters Optimized for various Ranges

| Application Max Range, kilometers | Laser* Emitter Diameter, meters |
|---|---|
| 1,000 | 1.009 |
| 10,000 | 3.192 |
| 100,000 | 10.093 |
| 1,000,000 | 31.915 |

*For lasers of wavelength 800 nm

It is apparent from the emitter diameters listed above that a power beaming laser described in this specification has a much larger emitter diameter than do lasers for cutting and welding. Those other uses are designed for intense (narrow) beams projected over close, near, or moderate ranges; whereas, a power beaming laser for beaming energy over long ranges (e.g., over distances of approximately 1,000 km or more) is designed as a very long range spotlight (focused or unfocused), such that it has a comparatively large emitter to minimize beam divergence over its design range. Expressed differently, a one-megawatt (MW) laser capable of penetrating steel plate at close range diverges too much at 10,000 km to power much of anything; whereas, a 1 MW power beaming laser is not able to cut steel at any range yet it is able to power a use at 10,000 km range with 1 MW minus the light-to-electricity-conversion loss given the use.

A high-power laser can be made by combining the outputs of numerous lower-power lasers. A beam-combining technique referred to as tiled aperture coherent beam combining (TACBC) can produce a long-range, high-powered spotlight. A power beaming laser can use an approach based on TACBC.

In summary, a power beaming laser can utilize a technique based on tiled aperture coherent beam combining (TACBC) to produce a high-power laser beam with an emitter diameter optimized to produce a beam that diverges so little from emitter to receiver that the beam diameter stays substantially within the dimensions of the receiver over a full range of operational distances and without requiring a receiver so large that it negatively impacts the function of the use being powered.

The emitter diameter of a power beaming laser is large enough to allow for a tiled aperture of similar size, meaning hundreds or thousands of laser beams can be combined into the single laser beam. The resultant laser can therefore be a high-power laser (e.g., one megawatt emitted) but with an intensity (power per unit area of the beam cross section) across its entire range that is directly usable by a photovoltaic receiver; namely, the power is spread out across the beam spot so that it doesn't exceed the intensities employed in commercial concentrator PV implementations. Such a power beaming laser is designed for laser-to-PV power beaming over long ranges.

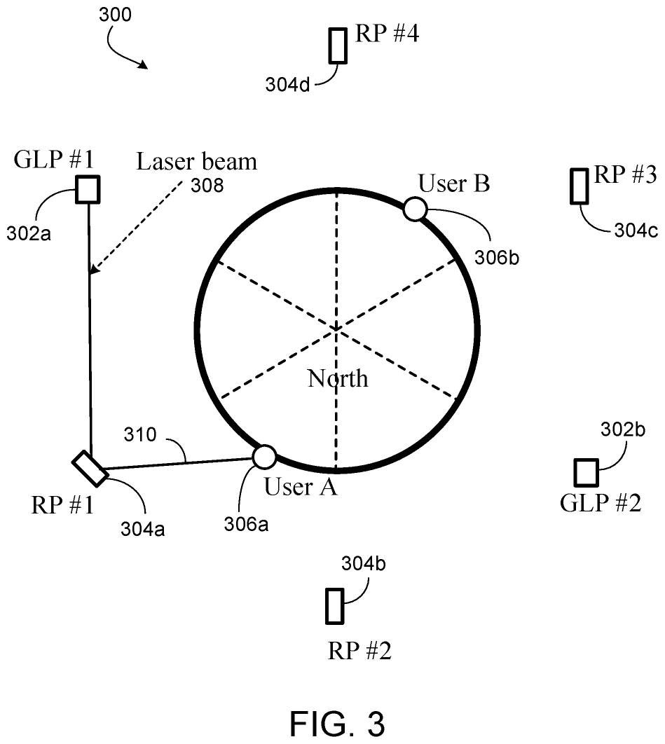

With reference to FIG. 3, a laser power beaming system deployed in orbit around the Earth (or other body) can include two types of platforms: Generating & Laser-beaming Platforms (GLPs) 302a, 302b and Relay Platforms (RPs) 304a, 304b, 304c, 304d.

A GLP can produce electricity from solar radiation, through the use of photovoltaic arrays, heat engines, and/or other means. For transmission to an end user, this electricity is converted to laser light using power beaming lasers on the GLP. A GLP 302a can directly target one or more of its lasers to a user/customer or may transmit power via one or more RPs, e.g., RP 304a. RPs can use optics (e.g., mirrors) to redirect the laser beam 308 from a GLP or another RP to a user/customer or another RP. Alternatively, the RP can collect an incoming laser beam 308 using a photovoltaic array, convert the incoming energy to electricity and retransmit at least some of the energy as a new laser beam 310.

The use of RPs allows the generating capacity of a GLP to be transmitted to users that are too separated from the GLP to be effectively serviced, or serviced at all, by the GLP directly. An example of too separated is angular separation (relative to the center of the Earth), as illustrated in FIG. 3, where GLP #1 can only be used to supply User A 306a or User B 306b through the use of an RP.

GLPs are more massive, complex, and substantial constructions and investments than are RPs. RPs therefore provide service flexibility to a laser beaming system in a more cost and resource efficient manner than would a system composed only of GLPs.

The use of RPs allows for an efficient allocation of GLPs among customers. The reasons for this efficiency becomes clear from examining the basic geometry of a GLP servicing a customer with and without the intermediate service of a RP.

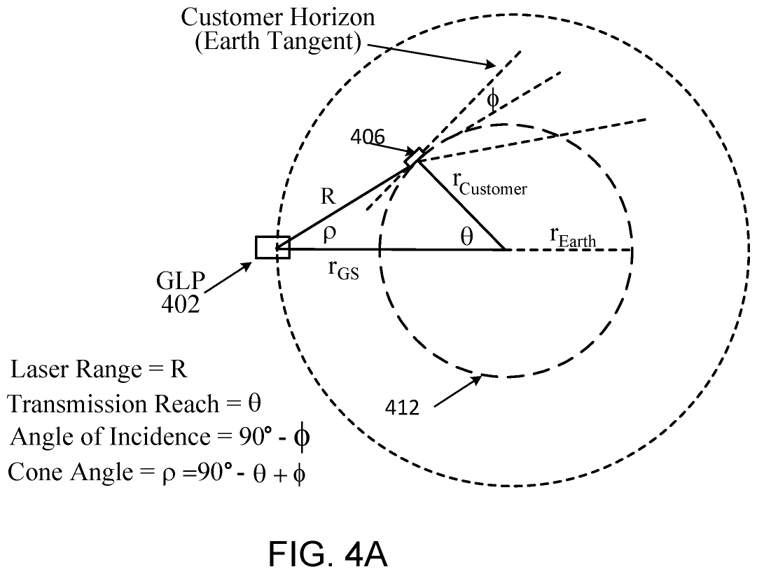

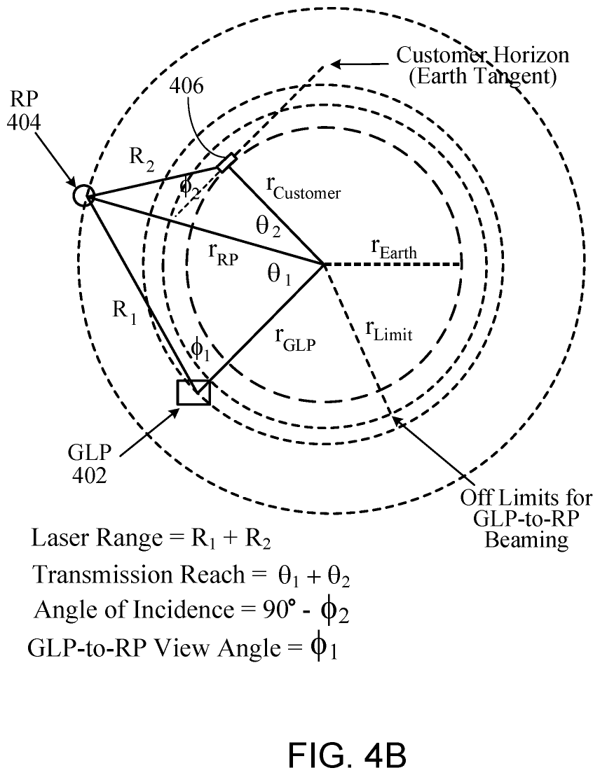

With reference to FIG. 4A, the customer 406 is either terrestrial (on land or water) or just above the surface (maximum cruising altitude of current commercial aircraft is less than 15 km). The solid lines form the service triangle between a GLP 402 and the customer 406. The sides of this triangle are: (i) the orbital radius of the GLP, r_{GS}, (defined from the center of the Earth 412); (ii) the radius of the customer, r_{Customer}; and (iii) the distance, or range, over which the laser transmits energy, R.

The angle ϕ is the complement of the angle of incidence of the laser to the customer (angle of incidence=90°−ϕ). This angle is important for two reasons: (i) The smaller is ϕ), the greater the amount of atmosphere that must be traversed (losses and beam distortion); and (ii) If the power receiver, e.g., the customer's photovoltaic (PV) array, cannot be articulated, then the power receiver reflects a higher percentage of incident photons as the ϕ decreases, lowering efficiency (also, the laser spot size can become impractically large).

The obtuse angle in the service triangle is 90°+ϕ. The other two angles are the transmission reach around the Earth, θ, and the cone angle, ρ, of the generation station relative to the customer. A restriction on minimum ϕ implies a larger r_{GS} (i.e., the GLP would then be placed in a higher orbit).

With reference to FIG. 4B, a RP 404 is illustrated transmitting energy between the GLP 402 and the customer/user receiver 406. What was a service triangle in the GLP-only, or one-level architecture, is now two triangles that share the orbital radius of the RP, rap. The first triangle is formed by sides r_{Customer}, R₂, and rip. The second triangle is formed by sides R₁, r_{GS} and r_{RP}. Note that these two triangles are only in the same plane when the generation station, relay station, center of the Earth, and customer are in the same plane; thus, the maximum realizable reach will vary by case and by the abundance of relay substations.

In this two-level architecture, the reach can be substantially larger than in the one-level architecture for the same laser range. For example, for an angle of incidence restriction of 45°, a 90° reach can be attained with a lower laser range than needed for a 35° reach in the one-level architecture. A 90° reach means that, given sufficient relay capacity, a GLP located anywhere in the entire hemisphere centered on a location can deliver power to the location. A two level architecture can provide up to three-times the coverage of a one-level architecture for the same number of GLPs.

In certain implementations, the generation capacity of an orbiting grid of GLPs is the sum of the generation capacities of all the GLPs individually. The delivered capacity at any point in time is the fraction of generation capacity that reaches customers. Air transport customers are distributed relative to terrestrial demand patterns and vary dramatically by location and time of day. Ocean transport patterns have additional variance due to weather. In certain implementations, a GLP grid system can configure a constellation of GLPs so that the GLP constituent orbits attempt to match these customer patterns. However, the smaller the constellation's reach, the lower is the average delivered capacity as a fraction of total generation capacity (i.e., more capacity goes unused).

RPs, e.g., stable mirror platforms, are simpler, lighter, and less expensive to build and deploy than GLPs. Thus a constellation of RPs, which in certain implementations can constitute an order of magnitude more RPs than the GLPs, can intermediate power distribution and dramatically increase average delivered energy capacity relative to total deployed generation capacity.

As shown in FIG. 4B, the use of RPs allows GLPs to be deployed into low orbits (e.g., a low Earth orbit has an altitude above the surface of less than 2,000 km) that are less costly to attain per unit mass. The option to place generation stations in low orbits is one consequence of the GLP constellation being decoupled from customer demand patterns by the intermediation of the RP constellation. Another consequence is that the GLPs can be deployed in sun-synchronous, near polar orbits that track the day-night dividing ring that clocks around the Earth, thereby experiencing 24-hour per day sunshine for most of the year decreasing slightly around the winter solstice with the extent of decrease depending on the particular sun-synchronous orbit used. The RPs can be placed into orbits that match demand, and, as they are inexpensive relative to GLPs, they can be deployed in sufficient numbers so that generation capacity from multiple GLPs is brought to bear on demand.

As noted above, without any intermediate relay, a GLP has limited reach around a planet to a customer due, first and foremost, to the planet getting in the way, with further limitations from too shallow an angle of incidence to the customer. Raising the orbit of a generating station (r_{GS}) increases the station's reach, but the range to the customer (thus beam divergence and control-loop delay) increases more rapidly than the reach, while any angle of incidence restriction places a limit on reach that is well below 90°.

A RP can increase reach for the same total range. This enables a GLP to service demanders over much of the Earth while maintaining a sufficiently tight beam and a sufficiently brief control-loop delay.

The benefit of employing relays is multiplied when a full system is considered; i.e., many thousands of customers serviced by an orbiting (thus moving) constellation of hundreds of GLPs and a few thousand RPs (note that in certain implementations an RP can service more than one customer at a time).

Customer demand is not uniformly distributed, yet orbital motion enforces a distribution of GLPs that does not regularly match the demand distribution. A RP is smaller and less expensive than a GLP. With enough RPs, the power output of many GLPs can reach shifting concentrations of demand.

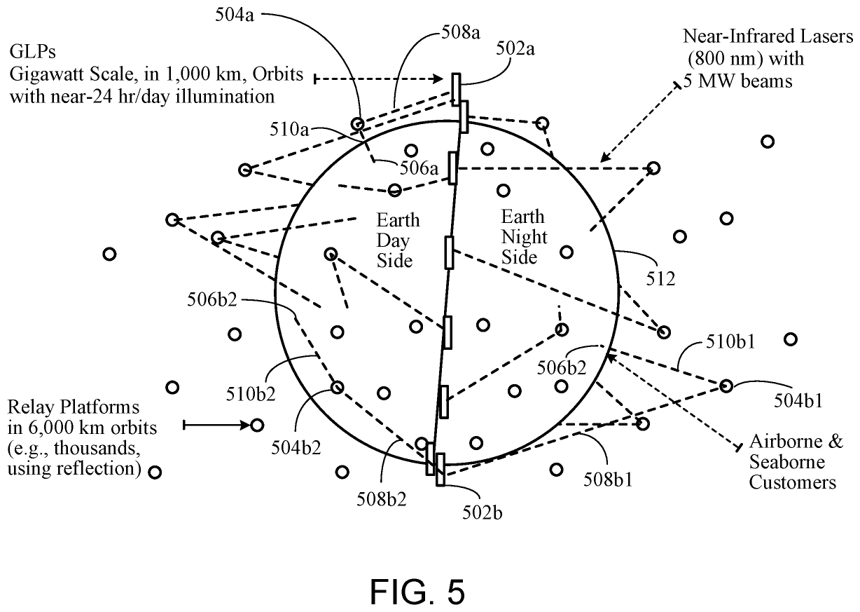

FIG. 5 illustrates an example of these two constellations, i.e., a GLP constellation (including a set of GLPs such as 502a and 502b) and a RP constellation (including a set of RPS such as 506a, 506b1 and 506b2), in operation. A two-level architecture of GLPs and RPs allows an orbiting power grid to service demand efficiently. Applying a multi-layer transmission architecture to wireless power transmission, e.g., to wireless power transmission featuring orbiting generation assets and terrestrial (air, sea, and land) customer satisfies a need for wireless power generation transmission including for solar generation platforms.

With reference to FIG. 5, a GLP 502a can beam energy to a RP 504a using beam 508a. RP 504a can relay the energy from beam 508a to user receiver/customer 506a using beam 510a. A different GLP 502b can beam energy to a RP 504b1 using beam 508b1. RP 504b1 can relay the energy from beam 508b1 to user receiver/customer 506b1 using beam 510b1. Similarly, GLP 502b can beam energy to another RP, i.e., RP 504b2 using beam 508b2. RP 504b2 can relay the energy from beam 508b2 to user receiver/customer 506b2 using beam 510b2.

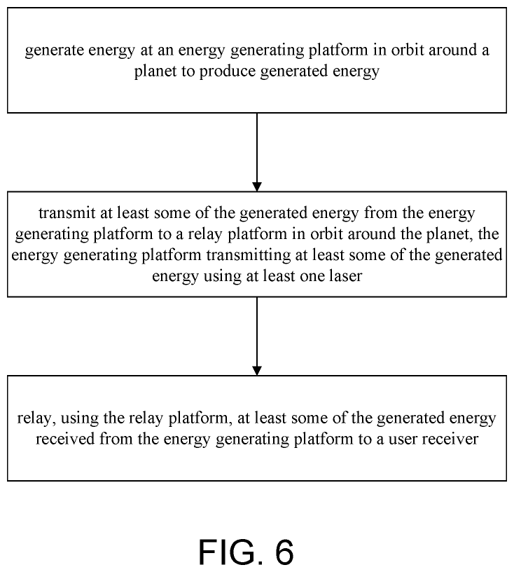

FIG. 6 is a flowchart of an example process 600 for orbital power transmission.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
generating energy at an energy generating platform in orbit around a planet to produce generated energy;
transmitting at least some of the generated energy from the energy generating platform to a relay platform in orbit around the planet, the energy generating platform transmitting at least some of the generated energy using at least one laser; and
relaying, using the relay platform, at least some of the generated energy received from the energy generating platform to a user receiver.

2. The method of claim 1, wherein transmitting at least some of the generated energy using at least one laser uses at least a first laser beam, wherein relaying the generated energy received from the energy generating platform to a user receiver comprises transmitting at least some of the generated energy using at least a second laser beam and wherein the energy generating platform and the relay platform are configured to transmit energy to a user receiver over a greater angular separation, as measured from the center of the planet compared to transmitting energy directly from the energy generating platform to the user receiver.

3. The method of claim 2, wherein transmitting at least some of the generated energy using at least a second laser beam comprises using a mirror on the relay platform to reflect the first laser beam and the second laser beam is a result of the first laser beam being reflected by the mirror.

4. The method of claim 1, wherein the relay platform comprises a relaying mirror and wherein relaying the generated energy comprises relaying the generated energy using the relaying mirror.

5. The method of claim 1, wherein relaying the generated energy comprises tracking and targeting, using the relay platform, the user receiver.

6. The method of claim 5, wherein transmitting at least some of the generated energy from the energy generating platform to a relay platform comprises tracking and targeting the relay platform.

7. The method of claim 6, wherein targeting the user receiver comprises using cooperative beam lock control.

8. The method of claim 1, wherein generating energy at an energy generating platform comprises the conversion of sunlight into electricity.

9. The method of claim 1 wherein generating solar energy comprises absorbing sunlight at a photovoltaic cell and converting the sunlight to electrical energy using the photovoltaic cell and wherein the method further comprises transmitting the electrical energy to at least one laser-based transmission system.

10. The method of claim 1, wherein the user receiver receives transmitted energy sufficient to provide at least 0.5 Megawatts of power.

11. The method of claim 1, wherein the total distance between the energy generating platform, relay platform, and the user receive is at least 1,000 km.

12. The method of claim 1, wherein the user receiver is selected from the group comprising an aircraft, a ship, and a stationary installation.

13. The method of claim 1, wherein the method further comprises:
generating energy at a plurality of energy generating platforms in orbit around the planet to produce generated energy;
transmitting at least some of the generated energy from the plurality of energy generating platforms to a plurality of relay platforms in orbit around the planet, each of the plurality of energy generating platforms transmitting at least some of the generated energy using at least one laser; and
relaying, using the plurality of relay platforms, at least some of the generated energy received from the plurality of energy generating platform to a plurality of user receivers, wherein the plurality of energy generating platforms and the plurality of relay platforms are configured relative to the plurality of user receivers such that the generated energy can be distributed among the plurality of user receivers while reducing surplus generation capacity and unfulfilled user energy demand relative to the same plurality of energy generating platforms without a plurality of relay platforms.

14. The method of claim 13, wherein the planet is Earth and wherein the plurality of energy generating platforms are in orbit around the Earth in sun-synchronous orbits that track a day-night boundary such that each of the plurality of energy generating platforms is in substantially-constant illumination from sunlight and wherein the plurality of relay platforms are in orbit around the Earth in orbits 6,000 kilometers or more above the Earth with orbital inclinations that facilitate the beaming of power to user receivers.

15. The method of claim 1, wherein transmitting at least some of the generated energy using at least one laser uses at least a first laser beam, wherein relaying the generated energy received from the energy generating platform to a user receiver comprises transmitting at least some of the generated energy using at least a second laser beam and wherein the energy generating platform, the relay platform, and the user receiver are configured such that the first laser beam and the second laser beam do not diverge more than a certain amount prior to arriving at their respective targets such that less than 15% of transmitted energy is lost.

16. A system comprising:
an energy generating platform in orbit around a planet, the energy generating platform comprising:
at least one photovoltaic cell configured to convert sunlight to electrical energy; and
at least one laser-based transmission system configured to receive electrical energy from the photovoltaic cell and to transmit at least some of the electrical energy as transmitted energy using at least one laser; and
a relay platform in orbit around the plant, the relay platform configured to receive at least some of the transmitted energy and to relay at least some of the transmitted energy to a user receiver.

17. The system of claim 16, wherein the system further comprises a user receiver configured to receive at least some of the transmitted energy.

18. The system of claim 16, wherein the energy generating platform is configured to transmit at least some of the electrical energy as transmitted energy using at least one laser producing at least a first laser beam, wherein the relay platform is configured to relay at least some of the transmitted energy to a user receiver by transmitting at least some of the transmitted energy using at least a second laser beam and wherein the energy generating platform and the relay platform are configured to transmit energy to a user receiver over a greater angular separation, as measured from the center of the planet compared to transmitting energy directly from the energy generating platform to the user receiver.

19. The system of claim 18 wherein transmitting at least some of the transmitted energy using at least a second laser beam comprises using a mirror on the relay platform to reflect the first laser beam and the second laser beam is a result of the first laser beam being reflected by the mirror.

20. A method comprising:
generating energy at an energy generating platform in orbit around a moon to produce generated energy;
transmitting at least some of the generated energy from the energy generating platform to a relay platform in orbit around the moon, the energy generating platform transmitting at least some of the generated energy using at least one laser; and
relaying, using the relay platform, at least some of the generated energy received from the energy generating platform to a user receiver.
